(19) United States
(12) Patent Application Publication
(10) Pub. No.: US 2023/0281688 A1
(43) Pub. Date: Sep. 7, 2023

(54) VIRTUAL REALITY/AUGMENTED REALITY AUTOMOBILE DEALERSHIP AND INTEGRATED BLOCKCHAIN NETWORK

(71) Applicant: Souhayl Errama, Tarzana, CA (US)

(72) Inventor: Souhayl Errama, Tarzana, CA (US)

(21) Appl. No.: 18/144,232

(22) Filed: May 7, 2023

Related U.S. Application Data
(60) Provisional application No. 63/317,482, filed on Mar. 7, 2022.

(51) Int. Cl. G06Q 30/0601; G06Q 20/40; G06Q 20/38; G06Q 20/36; G06T 19/00

(52) U.S. Cl. CPC G06Q 30/0611; G06Q 30/0643; G06Q 20/401; G06Q 20/389; G06Q 20/3678; G06T 19/003

(57) ABSTRACT

A system and method provide a virtual automobile dealership. The system may use virtual reality or augmented reality (VR/AR). Aspects of the system connect real-life auto dealership elements with metaverse elements through the VR/AR features. Dealers may clone their current inventory and a provide virtual sales experience without buyers having to be on the physical lot. A token (MCAR) may be provided that is used to exchange value within the ecosystem. Blockchain technology may be included that securely tracks transactions including changes in title, generation and transfer of NFTs, transfer/uses of digital tokens, and other elements.

### CROSS-REFERENCE TO RELATED APPLICATION

This application claims benefit under 35 U.S.C. § 119(e) of U.S. Provisional application having Ser. No. 63/317,482 filed Mar. 7, 2022, which is hereby incorporated by reference herein in its entirety.

### FIELD

The subject disclosure relates to network communications, and more particularly, to a system and method for a virtual reality/augmented reality automobile dealership and integrated blockchain network.

### BACKGROUND

The automotive industry has undergone a significant transformation in recent years as digital retailing has gained momentum. Customers now expect personalized and convenient experiences, and traditional dealerships and showrooms are struggling to keep up. They require substantial investments in physical infrastructure and personnel, limiting their reach and ability to provide immersive experiences.

Traditional brick-and-mortar automobile dealerships are limited by their geographical reach, lack of flexibility in conducting transactions, and inconvenient processes for customers. Buyers often have to visit multiple dealerships to explore vehicle options and negotiate prices, which can be time-consuming and frustrating. Additionally, the documentation and financing processes involved in purchasing a vehicle can be cumbersome.

Automotive dealerships have a great deal of difficulty educating and retaining the right people for digital retailing because of their high turnover. Our system is simple to use and allows anyone to advance in their automotive career while also generating actual cash for their dealership.

The quality of customer service and the time with which it is delivered are deteriorating. As will be appreciated from the disclosure below, the subject technology allows for real-time interaction with our trained AI or a salesperson as well as the most interactive digital experience ever seen by a customer. This enjoyable experience results in actual car sales. In contrast to the current fragmented lead procedure that's happening today.

### SUMMARY

In one embodiment of the present disclosure, a computer program product for generating a virtual automobile dealership platform is provided. The computer program product includes one or more computer readable storage media, and program instructions collectively stored on the one or more computer readable storage media. The program instructions include receiving, by a processor in a host computer server, a plurality of files associated with a physical automobile dealership. The files include: images of automobiles currently in stock, specifications associated with each automobile, images of a physical building of the automobile dealership, and digital avatars of personnel in the automobile dealership. A digital replica of the automobile dealership is generated. The digital replica includes a digital version of the automobiles currently in stock and a digital version of the physical building of the automobile dealership. A virtual or augmented reality environment is generated in a user interface that includes the digital replica of the automobile dealership. Digital access is provided to an end user of the generated virtual or augmented reality environment that includes the digital replica of the automobile dealership through the user interface. A real-time interaction between the end user and one or more of the digital versions of the automobiles currently in stock is generated through the user interface. The end user is able to walk around and sit in the digital versions of the automobiles currently in stock. A digital sales interface is generated in the virtual or augmented reality environment for transacting a sale of the one or more of the digital versions of the automobiles currently in stock. An inventory is updated to remove the digital version of the automobile in response to a sale of the digital version of the automobile. Upon determining, by the processor, that the digital version of the automobile has been sold, the virtual or augmented reality environment is updated, removing the digital version of the automobile from the digital replica of the automobile dealership and from view in the user interface.

In another embodiment of the present disclosure, a method of generating a virtual automobile dealership platform is provided. The method includes receiving, by a processor in a host computer server, a plurality of files associated with a physical automobile dealership. The files include: images of automobiles currently in stock, specifications associated with each automobile, images of a physical building of the automobile dealership, and digital avatars of personnel in the automobile dealership. A digital replica of the automobile dealership is generated. The digital replica includes a digital version of the automobiles currently in stock and a digital version of the physical building of the automobile dealership. A virtual or augmented reality environment is generated in a user interface that includes the digital replica of the automobile dealership. Digital access is provided to an end user of the generated virtual or augmented reality environment that includes the digital replica of the automobile dealership through the user interface. A real-time interaction between the end user and one or more of the digital versions of the automobiles currently in stock is generated through the user interface. The end user is able to walk around and sit in the digital versions of the automobiles currently in stock. A digital sales interface is generated in the virtual or augmented reality environment for transacting a sale of the one or more of the digital versions of the automobiles currently in stock. An inventory is updated to remove the digital version of the automobile in response to a sale of the digital version of the automobile. Upon determining, by the processor, that the digital version of the automobile has been sold, the virtual or augmented reality environment is updated, removing the digital version of the automobile from the digital replica of the automobile dealership and from view in the user interface.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a block diagram of a system providing a virtual automobile dealership platform according to an embodiment.

FIG. 1A is a block diagram of a network system architecture according to an embodiment.

FIG. 1B is a block diagram of a computing system representative of computing devices for use in embodiments of the subject technology.

FIG. 1C is a diagrammatic view of users interacting in a virtual reality environment from remote locations consistent with embodiments.

FIG. 2 is a flowchart of a method for generating a virtual automobile dealership platform according to an embodiment.

FIG. 3 is a flowchart of a method for generating a user interaction within a virtual reality or augmented reality automobile dealership according to an embodiment.

FIG. 4 is a flowchart of a method of simulating an automobile purchasing experience through a virtual reality environment according to an embodiment.

FIG. 5 is a flowchart of a method of replicating a digital twin of automobiles and automobile dealership elements consistent with embodiments.

FIG. 6 is a flowchart of a method of performing a smart contract based transaction in a virtual automobile dealership consistent with embodiments.

FIG. 7 is a block diagram of a blockchain network for use in embodiments of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

In general, the embodiments provide an augmented reality/virtual reality (AR/VR) virtual automobile dealership system that provides clients with an immersive experience. In one embodiment, the virtual dealership may be a stand-alone virtual entity that is generated digitally as a unique virtual location. In another embodiment, the virtual dealership may be a digital twin of an existing physical dealership that includes digitized replicated elements of the physical dealership.

To address the challenges associated with conventional dealership systems, the present disclosure offers a comprehensive virtual automobile dealership platform that leverages cutting-edge technologies to create a seamless and immersive experience for users. The platform combines AR/VR technologies, blockchain, and tokenization to provide a secure and transparent solution for purchasing, leasing, or renting vehicles in both the metaverse and the real world.

By integrating AR/VR, blockchain, and tokenization technologies, a virtual automobile dealership platform can be created that addresses the limitations of traditional dealerships and provides a more efficient, convenient, and secure means of purchasing and trading vehicles.

As will be appreciated, aspects of the virtual dealership system and platform hosting provide a practical application of virtual reality technology to a consumer experience. Features such as the digital twin generation of a physical (real-life) dealership and its inventory provide the end consumer with a simulated experience of visiting a dealership, seeing automobiles of interest first-hand (virtually) that may be physically present and readily available at the dealership, and simulating a test drive (free from the potential danger of crashing and/or damaging the car) without having to leave the comfort and safety of their home (or present whereabouts). The use of blockchain technology provides the non-conventional application that a virtually experienced automobile is the same one being purchased and delivered without fear of the item being switched or having a defective title. The tokenization feature provides a non-conventional application of digital currency that may be beneficial for users to avoid unexpected fluctuations in the value of vehicles purchased using the tokenized currency.

### Definitions

“Virtual reality” as used herein refers to a digital environment that includes a simulated experience of a three-dimensional environment providing a user an immersive feel of a virtual world.

“Augmented reality” as used herein refers to an interactive experience in at least a partial virtual environment that combines the real world and computer-generated content.

“Extended reality” as used herein refers to augmented reality (AR), virtual reality (VR), and mixed reality (MR) that combines or mirrors the physical world with a “digital twin world” that a user is able to interact with it.

“Smart contract” as used herein refers to a computer program or a transaction protocol that is intended to automatically execute, control or document events and actions according to the terms of a contract or an agreement.

“Blockchain” as used herein refers to a distributed ledger with growing lists of records (blocks) that are securely linked together via cryptographic hashes. Each block contains a cryptographic hash of the previous block, a timestamp, and transaction data. The timestamp proves that the transaction data existed when the block was created.

“Token” as used herein refers to digital assets represented on a blockchain by means of a smart contract.

“Non-fungible token” (NFT) as used herein is a unique digital identifier file that is recorded on a blockchain, and is used to certify ownership and authenticity.

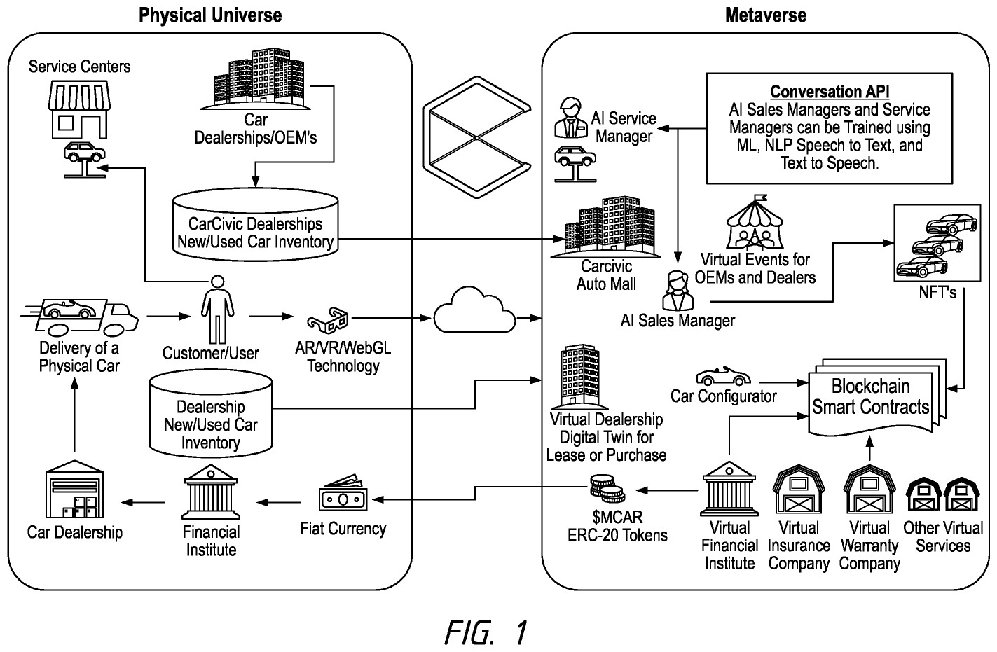

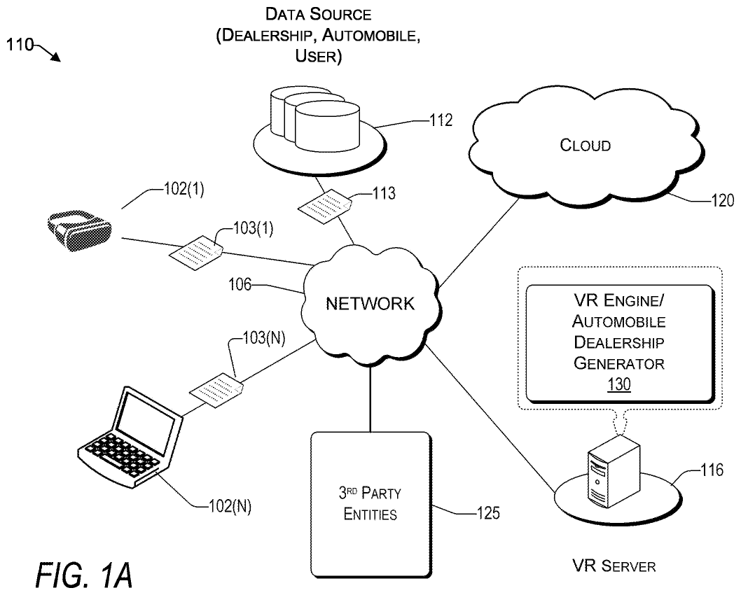

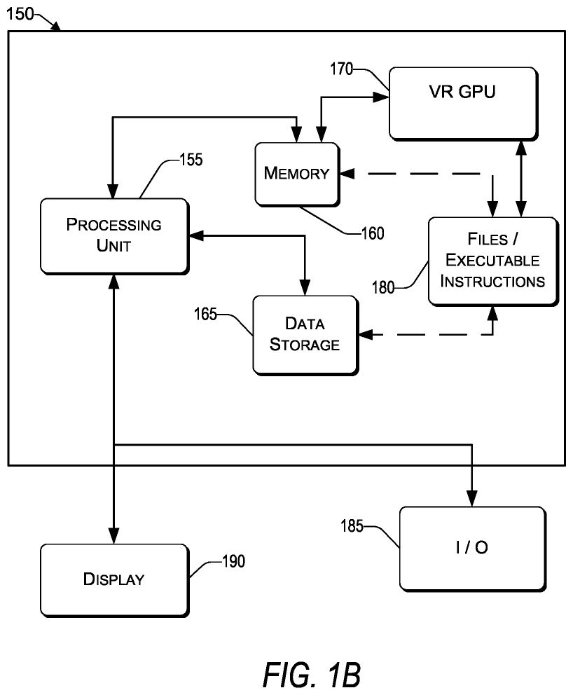

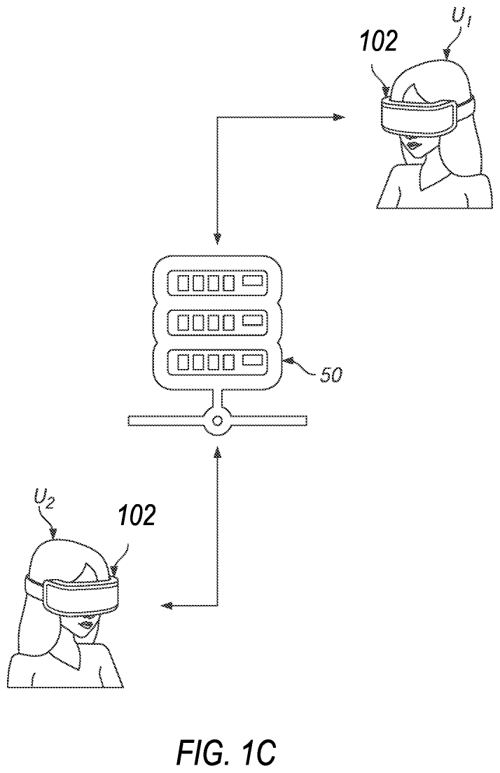

Referring now to FIG. 1, a system for providing a virtual automobile dealership platform is shown according to an embodiment. The system generally includes a physical universe side whose elements are affected by a metaverse side. The metaverse side includes a plurality of virtual elements that an end user can engage with through the user interface of a computing device (described in more detail below).

On the physical side, there are one or more automobile dealerships. Each dealership may have their own dedicated inventory of new or used cars. In other embodiments, dealership inventory may be pulled from a shared inventory location off-site from respective dealerships. An end user, typically a customer, may engage in a virtual (or augmented reality) experience by using a VR/AR device (or in some embodiments, an enhanced web-based experience). The end user may be remote from a dealership or in some embodiments (for example, in an AR embodiment), is physically on premises being provided an AR enhanced shopping experience. The AR/VR device is connected to a communications network (including for example, the Internet) that provides the end user to a metaverse side of the experience.

On the metaverse side, the system includes virtual reality generated experiences of a simulated real-life automobile shopping experience. For example, the end user may be presented with an auto mall of a plurality of dealerships congregated into a single location. Members of the auto mall are not necessarily physically located in a same mall location in the physical universe. For example, physical dealerships in different locations around a city or the world may join a metaverse auto mall and be associated as available for virtual visitation through the same auto mall interface. The UI may allow the user to select an individual dealership which may trigger zooming the perspective inward and generating the scene of the selected dealership to appear before the user's view. As may be appreciated, this feature eliminates the need for the end user to physically visit individual dealerships or travel between different dealerships on foot, which can be taxing on the user. In some embodiments, a selected dealership campus may be simulated as a digital twin replica of the physical dealership campus that can be visited in real-life in the physical universe. Users will appreciate that digital twin environments present a real-life experience of the traditional shopping feel, while providing confirmation of the real-life vehicles that are physically available to purchase. For example, an end user may see an advertisement for a particular car model that may be scarcely available and/or is listed for a desirable price. Instead of trekking down to the dealership, which may be hours away, the user may don the VR experience and see a virtual version of the particular car “first-hand”. The car may only be available for VR viewing (for example, if used or a limited number are in stock) if the car is on the physical dealership premises.

The metaverse side of the system may include an API that generates a UI for interacting with dealership personnel. The dealership personnel may be real-life personnel that are simulated in VR form, digitized using avatars, or may be entirely synthetic entities that operate using A.I. to communicate with end users.

When a selected car is purchased, the end user may be presented with other personnel and 3^{rd} party option services to transact the purchase similar to some dealerships that include a sales and finance area on site. The 3^{rd} party services may include a virtual financial institute, a virtual insurance company, a virtual warranty company, and other virtual companies related to the automobile purchasing experience.

In some embodiments, the metaverse interface may include a car configurator which provides the end user a platform to create a version of the car model with options that are customized to the user. If the car model with selected options is not on the premises, the end user may still order the car for manufacture and delivery. The end user may submit a deposit through the UI if the car is not available. This will allow a dealership operating under the subject technology to better serve customers and give them the assurance that their desired car will be available to them when they need it.

Some embodiments may include a financial ecosystem within the metaverse side of the overall system. For example, the system may include generation of its own digital currency. Digital currency may include a token based currency (labeled as “$MCAR” for illustrative purposes). In some embodiments, the tokens may be non-fungible. The purchase of tokens and automobiles may be performed through a blockchain using smart contracts. Smart contracts are employed to automate and secure various aspects of the transaction process, enabling users to transfer, sell, trade, or refinance their vehicles using the platform. End users will appreciate that by using smart contracts, tokens, and a blockchain ledger, the sales of tokens and automobiles are effectively secured from fraud. The title on an automobile purchased will be clean because the blockchain may detect when the vehicle's title has changed hands multiple times without a clean chain of title. The tokens used in the metaverse may be backed by the virtual financial institution, which may exchange the tokens for fiat currency in the physical universe that is transferred to the physical dealership.

In some embodiments, other automobile dealership services, for example, vehicle servicing and repairs, may be initiated through the metaverse interface. Service questions and appointments may be performed through the AR/VR experience which may be handled much faster than the traditional in-person experience.

Automobile dealerships may also appreciate that the metaverse of the present disclosure allows them to congregate into a virtual space for virtual events. While normally in distinct and sometimes distant locations from each other, dealerships may cooperate to hold virtual events such as new model year delivery sales events, virtual automobile conventions, and similar cooperative joint events that draw end users to the same virtual space. Dealerships no longer are required to set up physical booths and travel to demonstrate their product.

In addition to providing a more efficient and convenient way of purchasing and trading vehicles, the virtual dealership platform offers potential for advertising, sponsorships, and collaboration with original equipment manufacturers (OEMs), financial institutions, and other industry stakeholders.

The foregoing was a general overview of the virtual automobile dealership architecture and platform. Details of individual elements and technical backend processes are discussed in further details as examples below. Some of the individual elements and processes are further explained by block diagrams and flowcharts following the description of individual elements.

Virtual Showroom

Some embodiments include a virtual showroom that may be a three-dimensional (3D) representation of an existing brick-and-mortar dealership, created using advanced VR/AR technologies. The showroom is designed to closely mimic the layout, design, and ambiance of its physical counterpart, providing users with an immersive and realistic experience. The platform allows for easy navigation and interaction, enabling users to explore the showroom and examine various vehicle models on display. Some embodiments have a one-to-one appearance of a current physical showroom with the current inventory of cars on display. Other virtual showroom embodiments may be a blank slate platform onto which end users may select from an inventory of cars to inspect more closely through a VR or AR interface.

The virtual automobile dealership platform offers a 360-degree virtual showroom experience, allowing users to explore and interact with vehicles as if they were physically present at a dealership. Users can take a virtual walk around the vehicles, inspect interior and exterior features, and even open doors or engage with specific vehicle components. This interactive experience empowers users to make more informed decisions about their vehicle purchases, as they can closely examine and compare different models and options.

Virtual Vehicle Models

Each vehicle model in the virtual showroom may be represented as a highly detailed, interactive 3D model. These models allow users to explore the exterior and interior of the vehicles, customize options such as color, trim, and accessories, and even simulate test drives within the virtual environment. In some embodiments, the platform may convert physical vehicles into digital representations as NFTs, which can be used in the metaverse, allowing users to trade, sell, rent, or transfer their vehicles as digital assets.

Blockchain Technology and Smart Contracts

The platform utilizes blockchain technology to securely manage transactions, vehicle title changes, NFT generation and transfers, and digital token ($MCAR) activities. Smart contracts automate and secure various transaction processes, ensuring the integrity of the platform's records and enabling users to seamlessly transfer, sell, trade, or refinance their vehicles.

Metaverse and NFT Marketplace

The platform may feature a dedicated metaverse environment and NFT marketplace where creators, vendors, dealerships, and OEMs can upload and sell their digital creations, products, and merchandise as NFTs. This opens new revenue streams for dealerships and other stakeholders while offering users unique, virtual experiences and collectibles.

Real-World Vehicle Purchase and NFT Integration

As will be appreciated, the platform provides a seamless connection between real-world vehicle purchases and the creation of digital twins as NFTs in some embodiments. When a user purchases a vehicle from one of the participating dealerships and clients in the real world, they may be automatically granted a digital twin of their vehicle as an NFT. This NFT not only serves as a virtual representation of their vehicle but also contains all relevant vehicle data and documentation, such as vehicle title, lien holder information, and more, all securely stored within the NFT's smart contract.

This integration between real-world vehicle ownership and its digital counterpart simplifies future transactions involving the vehicle. Users can easily sell, transfer, or manage their vehicle-related documents and data through the NFT smart contract, providing a highly convenient and efficient solution for handling vehicle ownership matters in the digital age.

AI Salespersons

The platform employs A.I. generated salespersons, trained with extensive automotive data, to assist users throughout their shopping experience. These A.I. agents can answer questions about vehicle specifications, pricing, and availability, present financing options, and guide users through the documentation process when a deal is agreed upon. This not only streamlines the purchasing process but also provides a more personalized and efficient experience for users.

Integration with External Stakeholders

The virtual dealership platform offers the ability to integrate with external stakeholders such as OEMs, financial institutions, and other industry players. This facilitates collaborations, advertising opportunities, and allows dealerships to clone their inventories into the virtual environment. Financial institutions can provide virtual loan processing and pre-qualification services, further streamlining the purchasing process.

A.I.-Powered Car Configurator

In some embodiments, the platform features an A.I.-powered car configurator that enables users to customize their desired vehicle with ease. This tool uses machine learning algorithms and data from the automotive industry to suggest optimal configurations based on the user's preferences and requirements. The configurator may include geo-fencing technology, which allows the platform to locate vehicles near the user's location for real-world purchases.

API Integration

Embodiments of the virtual automobile dealership platform supports bi-directional API integration, enabling the platform to pull and push data to and from other systems. This allows for seamless data exchange with external systems, such as inventory management systems, customer relationship management (CRM) tools, and OEM databases. The API integration also ensures that the platform remains up to date with the latest vehicle information, promotions, and availability.

Geo-Targeted Advertising and Sponsorships

The platform provides opportunities for targeted advertising and sponsorships within the virtual showroom and metaverse environments. Businesses can showcase their products and services within the platform, targeting specific user demographics or locations for maximum impact and return on investment.

Security and Data Privacy

The platform incorporates robust security measures, such as end-to-end encryption and secure authentication protocols, to protect users' personal information and transaction data. In addition, the use of blockchain technology ensures that all transactions are transparent, secure, and tamper-proof.

Real-Time Inventory Synchronization

The platform synchronizes real-time inventory data with actual dealership inventories, ensuring that users can view and select from available vehicles at participating dealerships. This real-time synchronization eliminates the risk of users selecting vehicles that are out of stock or unavailable, streamlining the purchasing process and improving overall customer satisfaction.

In-Platform Communication and Collaboration

The platform enables users to communicate and collaborate with other users, A.I. salespeople, or real-world dealership representatives within the virtual environment (See for example, FIG. 1C below). This feature supports various communication modes, such as text chat, voice chat, or even video conferencing, depending on the user's device and preference. This seamless communication enhances the shopping experience and allows users to seek expert advice or consult with friends and family during the decision-making process.

Gamification and Rewards

Some embodiments, of the virtual automobile dealership platform incorporate gamification elements and reward mechanisms to engage users and encourage platform loyalty. Users can earn points, digital tokens ($MCAR), or other incentives by participating in platform activities, such as completing virtual test drives, attending events, or engaging with advertisements. These rewards can then be redeemed for various benefits within the platform ecosystem, such as discounts on vehicle purchases, exclusive access to limited edition NFTs, or special in-platform experiences.

Integration with Financing Institutions

The platform is integrated with financial institutions, such as banks and credit unions, to streamline the loan application and approval process. Users can apply for and secure auto loans within the platform, with the support of AI loan officers who can help them navigate the best loan options available. This integration simplifies the financing process, saving users time and effort, and expediting the overall vehicle purchasing journey.

Data Analytics and Personalized Recommendations:

The platform may include advanced data analytics and machine learning algorithms to provide personalized recommendations to users based on their browsing behavior, preferences, and interactions within the platform. By analyzing user data, the system can suggest relevant vehicles, promotional offers, or additional information that align with each user's unique needs and preferences. This personalized approach helps users to discover vehicles and options that they may not have considered previously, ultimately enhancing the overall shopping experience, and increasing the likelihood of a successful transaction.

Cross-Platform Compatibility

The virtual automobile dealership platform may be designed to compatibility with various computing devices and operating systems, ensuring that users can access the platform and enjoy a seamless experience regardless of their chosen device. This cross-platform compatibility extends the platform's reach and makes it accessible to a wide range of potential users, increasing the potential customer base for dealerships and OEMs.

Extended Reality Test Drives

In addition to the virtual showroom experience, the platform offers users the option to participate in extended reality (XR) test drives. These test drives can be experienced using virtual reality (VR), augmented reality (AR), or mixed reality (MR) technologies, allowing users to immerse themselves in a realistic driving experience without leaving their homes. XR test drives enable users to experience vehicle performance, handling, and features as if they were driving in real-life scenarios, providing valuable insights that can inform their purchasing decisions. The XR technology may include simulated vibrations, sounds, acceleration feel, bumps, and other environmental sensory experiences that replicate driving an automobile.

Social Sharing and Networking

The platform incorporates social sharing and networking features that allow users to share their experiences, vehicle choices, and virtual interactions with their social circles. Users can connect their social media profiles to the platform, enabling them to post updates, photos, or videos of their virtual dealership experience and inviting their friends and followers to join them in the platform. This social integration helps to promote the platform and drive user engagement, as well as create a sense of community among users.

Customized User Profiles and Preferences

Users can create customized profiles within the platform, enabling them to save their preferences, vehicle selections, and personal information. These profiles facilitate a more personalized user experience, with the platform tailoring its content, recommendations, and communications based on each user's unique preferences and requirements. Customized profiles also streamline the vehicle purchasing process by pre-populating relevant forms and applications with the user's stored information.

Automated Maintenance and Service Scheduling

The platform may support ongoing vehicle ownership and maintenance by integrating with vehicle service and maintenance providers. Users can schedule service appointments, receive maintenance reminders, and access their vehicle's service history within the platform, simplifying the management of their vehicle's upkeep. This integration further enhances the user experience by providing a comprehensive solution that supports users throughout the entire vehicle ownership lifecycle.

Dynamic Pricing and Real-Time Inventory Updates

The platform features dynamic pricing capabilities, allowing dealerships and OEMs to adjust vehicle prices in real-time based on market conditions, promotional campaigns, or user-specific incentives. By providing transparent and up-to-date pricing information, the platform empowers users to make well-informed purchasing decisions and simplifies the negotiation process. Furthermore, the platform is designed to sync with dealership and OEM inventory systems, ensuring that users have access to accurate, real-time information on vehicle availability and options.

Integration with Third-Party Services

The platform may support seamless integration with third-party services, such as insurance providers, vehicle financing companies, and other automotive-related service providers. By connecting users with these essential services directly within the platform, the invention simplifies the vehicle purchasing process and provides users with a one-stop-shop for all their automotive needs.

Platform Scalability and Customization

The platform's architecture may be scalable and customizable, enabling it to accommodate a wide range of dealership sizes, vehicle inventories, and user needs. The platform can be easily expanded or adapted to include additional features, services, or integrations as required by the evolving automotive industry landscape. This flexibility ensures that the platform remains relevant and valuable for dealerships, OEMs, and users in the long term.

Token Functionality and Purpose

The token within the ecosystem serves multiple purposes, primarily functioning as a digital currency for transactions in the virtual world (metaverse). The token may facilitate the exchange of value between users, dealerships, and other participants in the ecosystem. It allows consumers to earn, buy, and spend tokens on various automotive-related products and services, such as vehicles, accessories, and aftermarket items.

Token-to-Fiat and Fiat-to-Token Conversion

The system is enables seamless conversion of tokens into fiat currency and vice versa. This feature allows users to easily manage their financial transactions within the virtual dealership environment. It ensures that the value of the tokens can be readily realized and utilized by both consumers and businesses in the automotive industry.

Data-Driven Token Earnings

In some embodiments, consumers can opt-in to earn tokens by sharing their driving habits, vehicle data, maintenance, and repair information with the platform in real-time. This data-driven token earning approach incentivizes users to actively participate in the ecosystem and contribute valuable information, which can be utilized by dealerships, OEMs, and other stakeholders for market research, product development, and targeted marketing.

Token-Based Rewards and Incentives

Users who earn tokens by sharing their vehicle data can redeem these tokens for various automotive services and benefits, including free oil changes, maintenance, tire rotations, and rebates. This token-based reward system encourages consumer loyalty and participation in the ecosystem, as users benefit directly from their contributions to the platform. Additionally, this reward system provides automotive businesses with a novel and engaging way to offer value-added services, helping them to attract and retain customers in the increasingly competitive automotive market.

Cross-Platform Integration

The token can also be integrated with other metaverse platforms and digital ecosystems to enable a broader range of use cases, further enhancing its value and appeal to users. This cross-platform integration can facilitate partnerships with complementary businesses, service providers, and industries, creating synergies that drive growth and adoption of the token and virtual dealership platform.

Token Utility for Dealerships and OEMs

The token's utility extends beyond consumers, as dealerships and OEMs can use it to incentivize customer engagement, conduct promotions, or offer discounts on new vehicle purchases or services. By leveraging the token within their marketing and sales strategies, automotive businesses can benefit from increased consumer interaction, loyalty, and ultimately, revenue generation.

Community Governance and Tokenomics:

As the ecosystem grows and evolves, token holders may be given opportunities to participate in the platform's governance, enabling them to have a say in the platform's development and future direction. This community-driven approach to governance can further increase user engagement and create a strong sense of ownership among token holders, which can contribute to the long-term success and sustainability of the platform.

### Example Architecture

FIG. 1A illustrates an example architecture 110 for accelerating inference processing performance in AI modeling. Architecture 110 includes a network 106 that allows various computing devices 102(1) to 102(N) to communicate with each other, as well as other elements that are connected to the network 106, such as data source (or database) 112, a VR server 116, and the cloud 120. The VR server 116 may operate code including a module for running a VR engine/automobile dealership generator 130.

The network 106 may be, without limitation, a local area network (“LAN”), a virtual private network (“VPN”), a cellular network, the Internet, or a combination thereof. For example, the network 106 may include a mobile network that is communicatively coupled to a private network, sometimes referred to as an intranet that provides various ancillary services, such as communication with various application stores, libraries, the Internet, and in some embodiments, 3^{rd} party entities that may provide ancillary services to the end user for facilitating an automobile purchasing experience. The network 106 allows the VR engine/automobile dealership generator 130, which is a software program running on the VR server 116, to communicate with the data source 112, computing devices 102(1) to 102(N), and/or the cloud 120, to provide a simulated experience for an end user to shop for automobiles within a virtual reality environment. The data source 112 may include source data for images of dealership elements including for example: building exteriors, building interiors, floor plans, room layouts in the floor plans, showrooms, dealership lot appearances, lot maps, automobile exterior and interior appearances, and dealership personnel pictures. The data in the data source 112 may also include automobile specifications, automobile identification numbers of inventory currently in the dealership's physical stock, inventory status, and current physical locations of automobiles in the physical automobile dealership. When a request is made by the VR server 116 to generate a VR environment, data packets 113 carry any of the information described above for the VR engine/automobile dealership generator 130 to use to replicate real-life elements in the physical dealership within a VR environment. In one embodiment, the data processing is performed at least in part on the cloud 120. In some embodiments, network 106 and/or the cloud 120 may be used to access a blockchain network (described further below).

For purposes of later discussion, several user devices appear in the drawing, to represent some examples of the computing devices that may be the source of data being analyzed depending on the task chosen. Aspects of the symbolic sequence data (e.g., 103(1) and 103(N)) may be communicated over the network 106 with the VR engine/automobile dealership generator 130 of the VR server 116. Today, user devices typically take the form of portable handsets, smart-phones, tablet computers, personal digital assistants (PDAs), and smart watches, although they may be implemented in other form factors, including consumer, and business electronic devices. As shown, the computing device 102(1) is represented as a VR headset type device providing an immersive experience, however, it will be understood that an end user may use any of several available VR type devices and in some embodiments, the VR environment is not necessarily immersive. While the data source 112 and the VR engine/automobile dealership generator 130 are illustrated by way of example to be on different platforms, it will be understood that in various embodiments, the data source 112 and the VR server 116 may be combined. In other embodiments, these computing platforms may be implemented by virtual computing devices in the form of virtual machines or software containers that are hosted in a cloud 120, thereby providing an elastic architecture for processing and storage.

### Example Computing Machine Architecture

FIG. 1B shows a general computing device 150 is shown according to an exemplary embodiment. It will be understood that a “computing device” may serve different roles depending on the need in the system or depending on the step being performed in a process. For example, in the role of a web server, a host server, or an online platform server, a computing device may implement for example the functions related to backend process (for example, those described with respect to FIGS. 1, 1A, 1C and throughout). In the aforementioned roles, the computing device may also coordinate the virtual reality output and transaction with 3^{rd} party entities outside of the system 110 generated by the backend for display on frontend interfaces of client computing devices (for example, those shown as the computing device 102 in FIG. 1A). In another role, the computing device may be a repository of data connected via a network, from which the backend processing computing device(s) retrieve their data. In the role of a user device, the computing device 150 is generally not a server but may instead be VR headsets, HUDs, desktop computers, tablet or laptop computers, all-in-one computer stations, a mobile computing device (for example, a smart phone, smart wearable devices (glasses, jewelry, watches, ear wear, etc.), or programmable electronics. As will be understood, the user device may generally provide frontend aspects of the system. In some embodiments however, the frontend computing device may perform one or more of the backend steps where possible.

The components of the computing device 150 may include, but are not limited to, one or more processors or processing units 155, a system memory 160, data storage 165, a computer program product 180 having a set of program modules including files and executable instructions, and a bus system that couples various system components including the system memory 160 to the processor(s) 155. The memory storage 160 may store for example, archived data related to historical searches and stored driving factors or predictive values. Some embodiments of the computing device 150 may include a graphics dedicated processing chip (GPU) 170 configured for processing virtual reality image data.

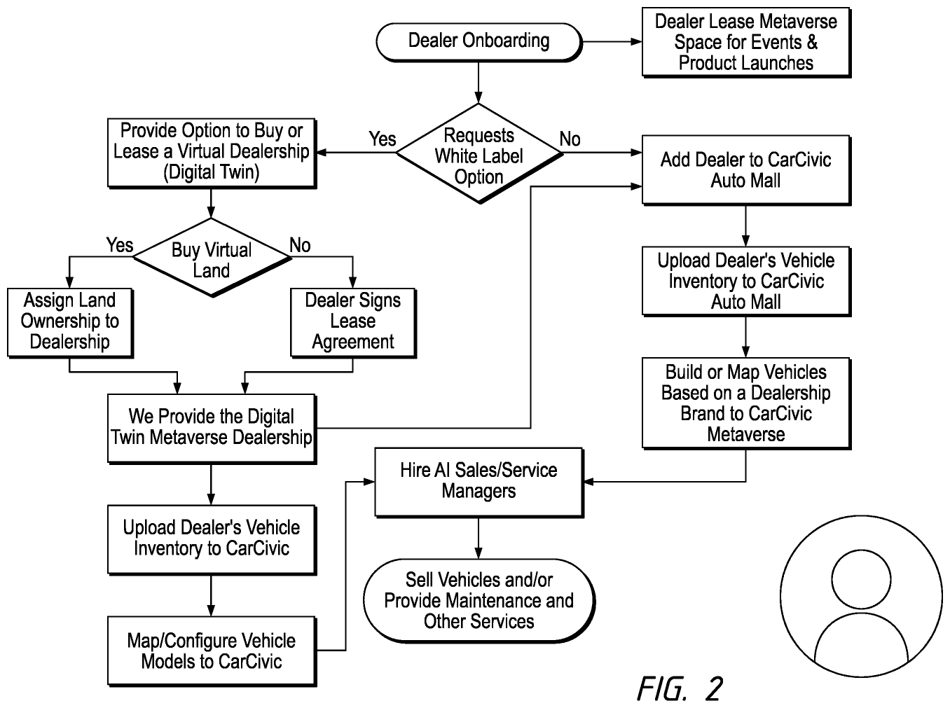

The computing device 150 may be described in the general context of computer system executable instructions, such as the program modules which represent a software embodiment of the system and processes described generally below with respect to FIGS. 2-4, 4A, and 5. The program modules generally carry out the functions and/or methodologies of embodiments described herein. The computing device 150 may typically include a variety of computer system readable media. Such media could be chosen from any available media that is accessible by the computing device 150, including non-transitory, volatile and non-volatile media, removable and non-removable media for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing. The system memory 160 could include one or more computer system readable media in the form of volatile memory, such as a random-access memory (RAM) and/or a cache memory. By way of example only, the data storage system 165 may read from and write to a non-removable, non-volatile magnetic media device. The system memory 160 may include at least one program product 180 having a set of program modules that are configured to carry out the functions of embodiments of the invention in the form of computer executable instructions. The program product/utility 180 may be stored in the system memory 160 by way of example, and not limitation, one or more application programs, other program modules, and program data. Some embodiments may generate an electronic user interface (viewable and controllable from the display unit 190) that may allow the end user to enter a VR setting or for an administrative user to perform administrative functions from the host platform side of the system 100.

The computing device 150 may communicate with one or more external devices including for example, a peripheral form of the electronic display 190 which may in some embodiments be configured for tactile response as in a touch screen display. User input into the display 190 may be registered at the processor 155 and processed accordingly. Other devices may enable the computing device 150 to communicate with one or more other computing devices, either by hardwire or wirelessly. Such communication can occur via Input/Output (I/O) interfaces/ports 195.

The computing device 150, through the I/O interface/ports 195, may communicate with one or more networks such as a local area network (LAN), a general wide area network (WAN), and/or a public network (e.g., the Internet) via a network adapter as is commonly known in the art. In some embodiments, the computing device 150 may be a cloud computing node connected to a cloud computing network (for example cloud environment 120 shown in FIG. 1). The computer computing device 150 may be practiced in distributed cloud computing environments where tasks are performed by remote processing devices that are linked through a communications network. In a distributed cloud computing environment, program modules may be located in both local and remote computer system storage media including memory storage devices.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “module”, “circuit”, or “system.” Furthermore, aspects of the disclosed invention may take the form of a computer program product embodied in one or more computer readable media having computer readable program code embodied thereon. In some embodiments, the output of the computer program product provides an electronic user interface on the display 190 which may be controlled via direct contact with the display 190 or via the I/O interfaces 960 (which may be for example, interface devices such as keyboards, touchpads, a mouse, a stylus, or the like).

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 155 of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks in the figures.

### Example Communication Scheme

FIG. 1C shows two users (U₁ and U₂) interacting with a virtual reality platform 50 (that may be hosted by the VR server 116 of FIG. 1A) through a respective virtual reality type computing devices 102. In some embodiments, the user U₁ is inside a virtual environment where he or she engages with a digital replica (digital twin) of a selected automobile dealership from the physical world. The user U₂ may be a representative of the automobile dealership (for example, a salesperson, service representative or manager, accounting department representative, etc.) that appears before U₁ in the virtual reality dealership. A replica of the personnel may be shown or some other digital avatar may be displayed to represent U₂.

As will be appreciated, end users may conveniently engage in an automobile shopping experience from the comfort of their own homes. Aspects of the system 100 bring a new geo-fenced sales channel to a dealer's store that allows for finance applications, F&I products, and delivery setup of the actual vehicle in their inventory.

Embodiments may include an A.I. salesperson that mimics a physical salesperson with formal training. A conversational A.I. based avatar may be included that has been properly trained to manage the selling process. For example, a real-time interaction between the end user and one or more of the digital avatars of personnel in the automobile dealership may be generated. The real-time interaction includes one of the digital avatars asking the end user questions, answering questions from the end user, and pointing out features of the digital versions of the automobiles. In the metaverse, the end user may be invited to do a comprehensive walkaround, reducing phone-ins and e-mails, while increasing appointments and sales.

In augmented reality embodiments, the user U₁ may be in a physical world but seeing the world through augmented reality (AR) through the device 102. For example, the user U₁ may visit the physical automobile dealership and don the AR type computing device 102. An empty show room may be physically present, however, VR engine 116 (FIG. 1A) may display AR generated automobiles within the user U₁ AR line of sight.

### Example Dealer Participation Methodology

FIG. 2 shows a method for dealer onboarding into the system and platform of the present disclosure. In some embodiments, a prospective dealer entity may generally directly lease metaverse space for events and product launches.

In another embodiment, a dealer may request entry into metaverse participation by requesting a white label option. Under the white label option, the dealer may buy or lease a virtual dealership (sometimes the digital twin of an existing dealership) under another brand's label. The dealer may purchase virtual real estate in the metaverse or lease a space. Another entity, for example, a platform host, may provide the generation of a digital twin dealership to the dealer. The digital twin may be a replica of the dealer's dealership or of another dealer's dealership (which may be beneficial to brokers that do not physically own a real-life lot). The dealer's inventory may be uploaded and mapped to the platform. In the alternative that the dealer does not want a white label option, the dealer's business may be added directly to the platform. The dealer under either option conducts business in the virtual reality version of the dealership as described in embodiments above.

### Example End User Consumer Participation Methodology

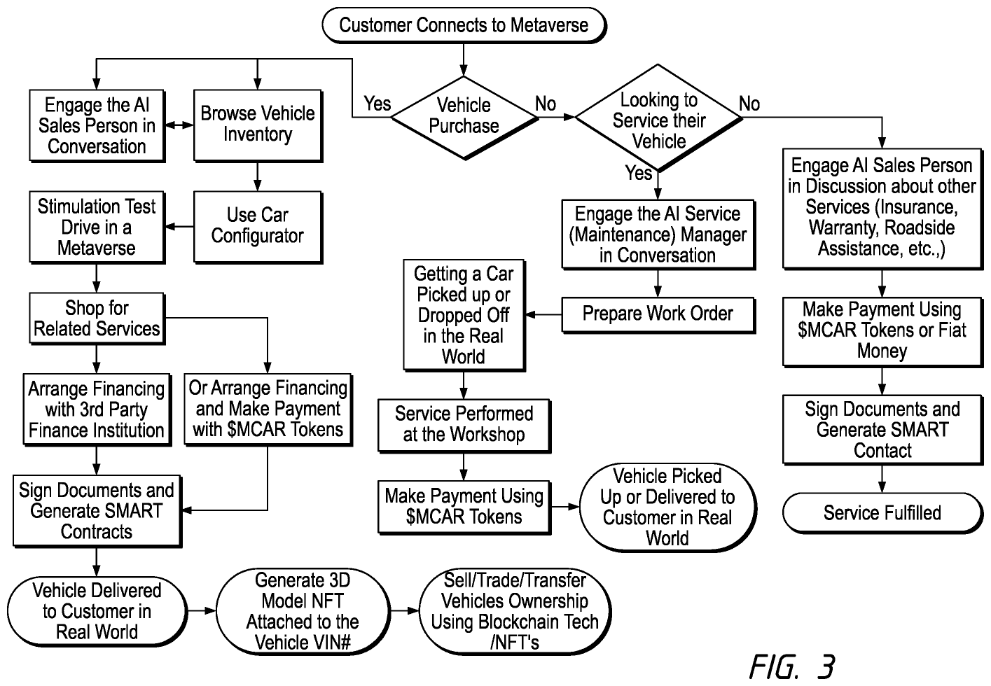

Referring now to FIG. 3, a process of user interaction with a virtual reality automobile dealership of the present disclosure is shown according to an embodiment. The process generally begins with the user connecting to the metaverse through a VR or AR enabled device. The user, through a user interface, may initially be presented with an option to select their purpose for a visit. In other embodiments, the UI may show a replica automobile dealership from which the user may select by click, gesture or other I/O command a feature of the dealership or menu item. For example, the user may select a front door of the dealership building or an automobile on the lot. Such a selection may trigger activation of a salesperson function. A menu option may include activation of a car configuration module. The user may proceed in the VR experience by selecting or asking for different kinds of assistance through the UI including initiating a simulated test drive, shopping for related services, shopping for related services, arranging financing under different options, and electronically signing documents and/or smart contracts. Upon confirmation of a sale, the user vehicle may be delivered to the user's designated address of receipt. Some embodiments may automatically trigger generation of a NFT that is attached to the purchased vehicle by vehicle identification number (VIN). The NFT may be transferred as title of the vehicle changes hands in future transactions, which may be tracked by a blockchain network.

Other services may be initiated by the user, including for example, requesting vehicle servicing, insurance coverage, roadside assistance, and warranty coverage. For vehicle servicing, the UI may include a servicing request menu that triggers pick-up of the vehicle from a user designated location (or notice that the vehicle is being dropped off in real-life). Payment for servicing or other services may be performed in the metaverse using tokens accepted by the instant metaverse, including its own token currency. Fiat currency may be accepted in some embodiments. Some service embodiments include delivering the vehicle to the user in real-life once servicing is done.

### Example Virtual Reality Automobile Dealership Generation and Experience

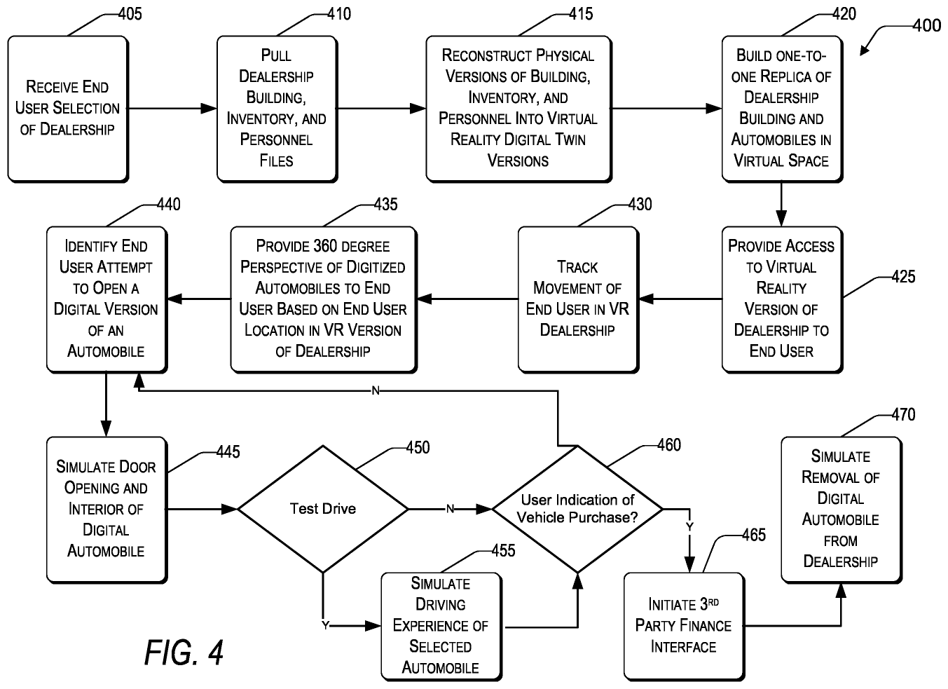

FIG. 4 shows a method 400 of simulating an automobile purchasing experience through a virtual reality environment according to an embodiment. Actions triggered by the end user and machine elements may be performed generally by the elements shown in FIG. 1A, thus concurrent reference to FIG. 1A is required while reviewing the blocks in FIG. 4. A user selection through VR/AR device is received 405 by the VR server 116. The VR server 116 may pull 410 dealership building, inventory, and personnel files from the data source 112. The VR engine/automobile dealership generator 130 may reconstruct 415 physical versions of the dealership building (exterior and interior elements), automobile inventory, and personnel likenesses into virtual reality digital twin versions of the real-life elements using for example, virtual reality software generation programs. The exterior or automobiles may be re-created. The interior of automobiles may be re-created and visible through virtual windows of the automobiles. The VR engine/automobile dealership generator 130 may build 420 a one-to-one replica of the automobile dealership building and of automobiles in the dealership within the virtual reality space. In some embodiments, the automobiles currently in inventory may be positioned in the virtual space in a corresponding real-life location in the real-life physical dealership building or lot. For example, cars tracked to a designated slot in the lot may be displayed in a corresponding virtual slot in the virtual dealership lot. Cars that are currently on display in the physical showroom may be displayed virtually in the same space of the corresponding virtual showroom. The positions of virtual automobiles in the virtual space may change as the real-life position of automobiles in the physical dealership changes.

When the virtual reality version of the automobile dealership is built, the VR server 116 may provide 425 electronic access to a consumer end user through a VR interface. The VR engine/automobile dealership generator 130 may track 430 the movement of the end user through the virtual automobile dealership. When the end user moves, the VR engine/automobile dealership generator 130 may continuously update 435 the perspective of a virtual automobile relative to the end user's VR perspective. As the end user in the VR space approaches an automobile, the VR engine/automobile dealership generator 130 may identify 440 when the user attempts to open the door of the virtual automobile. The VR engine/automobile dealership generator 130 may simulate 445 movement of the virtual door opening and may simulate the automobile interior. The user may engage the automobile by entering into the simulated interior by sitting in the virtual seats. The VR engine/automobile dealership generator 130 may generate first-, second-, or third-person perspective points of view so that the end user experience the interior under real-life simulation but can also see what they look like in the automobile from other perspectives.

In some embodiments, the end user may engage with simulated functionality of the automobile selected. Interior features such as control panels, displays, audio systems, environmental controls (heating/air-conditioning) and the like may be provided via extended reality. The user may request a simulated test drive 450 which triggers 455 a driving simulation experience of operating the automobile in the virtual neighborhood or other simulated road/track (for example, freeway, racing track, etc.).

In some embodiments, the user interface (via processor unit) or a digitized salesperson may inquire 460 whether the end user is interested in purchasing the vehicle. A negative response or continued interest to browse by the end user may continue the VR experience by exiting the virtual automobile and browsing additional vehicles (or leaving the virtual dealership). An interest to purchase the automobile may generate interaction with one or more of the virtual personnel and/or the UI may trigger 465 opening a 3^{rd} party finance interface displayed through the VR interface.

Whether the automobile is purchased through a 3^{rd} party finance entity or directly by the end user, some embodiments of the platform may simulate 470 the release of the vehicle by removing the purchased automobile from the virtual dealership. For example, an animation may show a replica of the end user driving off with the vehicle and the virtual location of the vehicle being updated as empty to simulate that the corresponding real-life automobile has been removed from inventory in the physical dealership.

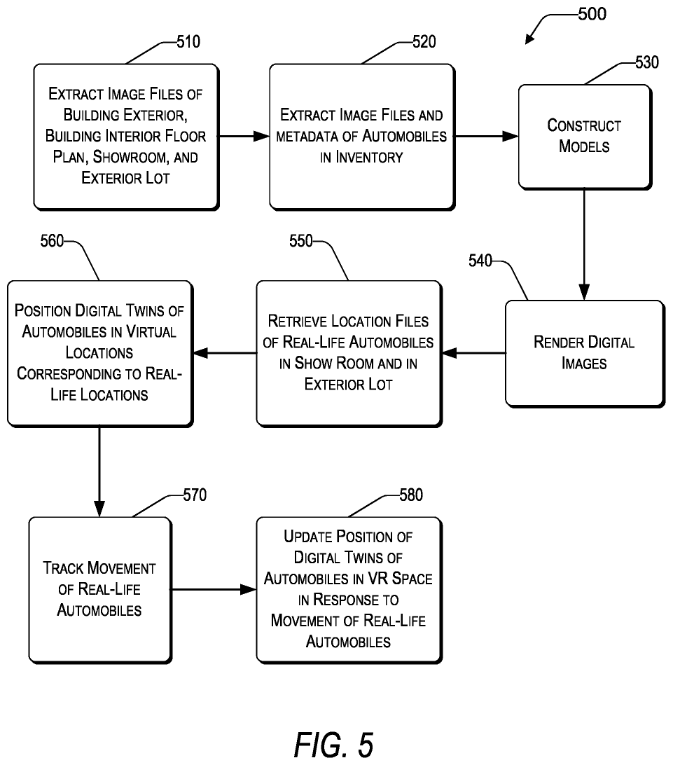

Referring temporarily to FIG. 5, a method 500 of replicating a digital twin of automobiles and automobile dealership elements is shown in more detail according to an embodiment. Files may be extracted 510 and 520 by the VR engine/automobile dealership generator 130 of buildings and automobiles, which may include image data, metadata, specifications, and other data used to generate virtual imagery. For example, pictures and image scans of the buildings, their floor plans, room appearances may be stored as files. The dealership lot along with images of landscaping, parking space designations, and any indicia elements may be stored. The current location of any vehicle in a tracked parking slot may be stored and updated when the vehicle is moved and re-parked. Pictures of personnel may be on file. Using the extracted data, the VR engine/automobile dealership generator 130 may construct 530 models of the VR elements. The VR engine/automobile dealership generator 130 may render 540 digital images of the models in a virtual reality format. The VR engine/automobile dealership generator 130 may retrieve 550 the current location of real-life automobiles in the dealership from the metadata. The locations may include the dealership showroom and the exterior lot. The VR engine/automobile dealership generator 130 may position 560 the digital images of replicated automobiles in their virtual location that corresponds to the real-life physical location in the dealership. As real-life automobiles are moved (for example, having been taken for a test drive or re-positioned for prominent display/removal from prominent display), the VR engine/automobile dealership generator 130 may track 570 the movement and may update 580 the position of the digital twin inside the virtual space.

### Example Smart Contract Methodology

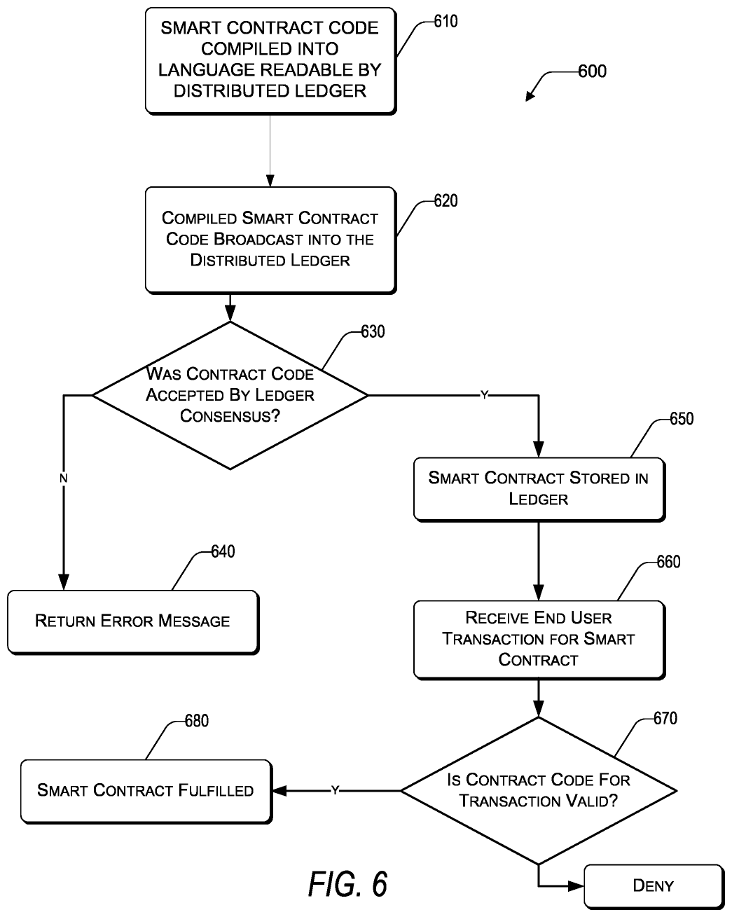

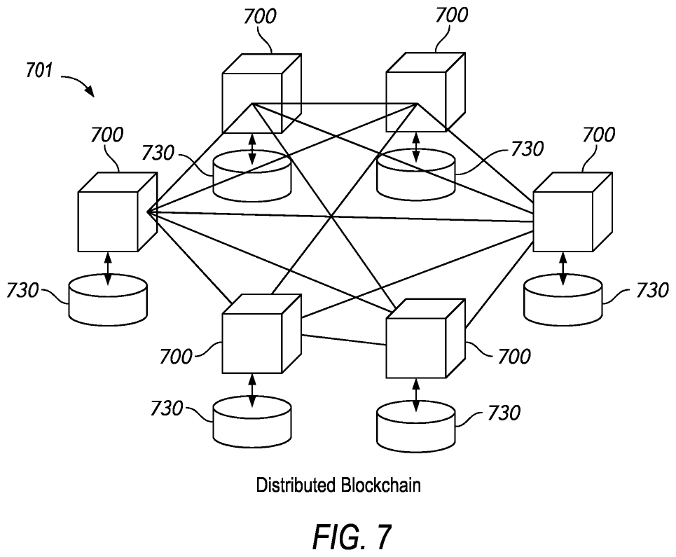

Referring now to FIG. 6, a method 600 of generating a smart contract for an automobile related transaction is shown according to an embodiment. A computer processor (for example, the processing unit 155 of a general computing device 150 of FIG. 1B) may compile 610 smart contract code into a digital tangible asset that outlines the criteria for fulfilling purchase and sale of an automobile through a virtual reality platform. In one embodiment, the smart contract and its rules may be assembled into a digital token (for example, a token that may be used exclusively in the host platform of the instant disclosure or one that may be generated as a digital currency for cross-platform exchange). The smart contract provides a “signed” transaction in electronic form which can be immediately (or at a later date) “broadcast” 620 into a network such as a blockchain ledger. An example of a blockchain 701 is shown below in FIG. 7. A reference to this unique token can be known ahead of time or may be provided by the network after submission and acceptance.

Events trigger actions on a token. Events can happen within the network or triggered by some external mechanism (API call, system call). Events may trigger for example, a change in the properties of a token, adjustment in value, a transfer in ownership, an assignment of new properties, an addition or adjustment of new owners, and/or an addition, removal or adjustment of rules. Events may destroy tokens as well. The parts of a token that are allowed to be modified or interacted with may be specified at the token's creation. The token may also restrict modifications, preventing the owner and/or creator from adjusting all or some properties of the token.

A smart contract in the subject platform may be broadcast 620 into the ledger for acceptance 630 and ledger consensus. If consensus is not reached, an error message may be returned 640. If accepted, the contract is stored 650 and history related to the contract is tracked. For example, the blockchain may determine 670 whether the end user's obligation under the smart contract has been fulfilled 660. If the end user's actions are validated 670 (for example, payment and purchase by a single tracked entity is determined), then the processor may determine that the smart contract is fulfilled 680. Title and chain of custody may be recorded in the blockchain and used in the future to track current ownership and changes in ownership. The tokenized ownership may be considered a historic, cryptographically provable and immutable group of events that have taken place across the network.

### Example Blockchain Methodology

Referring to FIG. 7, illustrative embodiments of the subject technology provide a new blockchain solution that allows one to buy, sell, or trade your car in the metaverse and in the real world, with special incentives for $Mcar token holders. FIG. 7 shows a distributed ledger 701 that may be used in conjunction with the methods 400 and 600 disclosed above in FIGS. 4 and 6. The distributed ledger 701 may generally comprise a plurality of computing devices 700 (which may operate under the description provided for computing devices 150 shown in FIG. 1B), with each device including a database 730 storing data including copies of authenticated documents and metadata which may be referenced during verification processes of smart contract transactions. The database 730 may be consensually shared and synchronized across a network spread across multiple sites, institutions or geographies. The distributed ledger database (which includes the multiple database repositories 730 of each computing device 700) is spread across several nodes (computing devices 700) on a peer-to-peer network, where each replicates and saves an identical copy of the ledger and updates itself independently. When a ledger update happens (for example, when a particular automobile is purchased), each node constructs the new transaction, and then the nodes vote by consensus algorithm on which copy is correct. Once a consensus has been determined, all the other nodes update themselves with the new, correct copy of the ledger. Security is accomplished through cryptographic keys and signatures.

The distributed ledger 701 may be a blockchain network in some embodiments, which is a ledger that records a history of transactions between all the users since its creation. The blockchain of the instant disclosure permits the storage and transmission of information including fulfillment of smart contract criteria, purchase/sales of digital tokens, and transfer of ownership of automobiles and/or tokens. The database is distributed, which means the transactions are validated by a consensus process and shared to all the participants (Peer-to-peer). The blockchain allows counterparties to make secured direct transactions without a central intermediary. Trust is ensured through a mutual consensus verification protocol. The set of rules and procedures for authenticating and validating the information are added to the distributed ledger by the members of the network (all the members or a majority). In some embodiments, token holders are empowered to take control of their new car purchases through the tokenization of real-world assets, NFTs, and a strong community. The global community will be granted transparency and efficiency, while costs and friction of car buying may be minimized. Some embodiments may include incentives for token holders of tokens generated by the system of FIG. 1.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A computer program product for generating a virtual automobile dealership platform, the computer program product comprising:
one or more computer readable storage media, and program instructions collectively stored on the one or more computer readable storage media, the program instructions comprising:
receiving, by a processor in a host computer server, a plurality of files associated with a physical automobile dealership, wherein the files include:
images of automobiles currently in stock,
specifications associated with each automobile,
images of a physical building of the automobile dealership, and
digital avatars of personnel in the automobile dealership;
generating a digital replica of the automobile dealership, wherein the digital replica includes a digital version of the automobiles currently in stock and a digital version of the physical building of the automobile dealership;
generating, by the processor, a virtual or augmented reality environment in a user interface that includes the digital replica of the automobile dealership;
providing digital access to an end user of the generated virtual or augmented reality environment that includes the digital replica of the automobile dealership through the user interface;
generating a real-time interaction between the end user and one or more of the digital versions of the automobiles currently in stock through the user interface, wherein the end user is able to walk around and sit in the one or more of the digital versions of the automobiles currently in stock;
generating a digital sales interface in the virtual or augmented reality environment for transacting a sale of the one or more of the digital versions of the automobiles currently in stock;
updating an inventory to remove the one or more of the digital versions of the automobiles currently in stock in response to a sale of the one or more of the digital versions of the automobiles currently in stock; and
upon determining, by the processor, that the one or more of the digital versions of the automobiles has been sold, electronically and automatically updating the virtual or augmented reality environment, removing the one or more of the digital versions of the automobiles from the digital replica of the automobile dealership and from view in the user interface.

2. The computer program product of claim 1, wherein the program instructions further comprise generating a real-time interaction between the end user and one or more of the digital avatars of personnel in the automobile dealership, wherein the real-time interaction includes one of the digital avatars asking the end user questions, answering questions from the end user, and pointing out features of the one or more of the digital versions of the automobiles.

3. The computer program product of claim 1, wherein the program instructions further comprise generating a digital showroom replicating a real-life showroom in the physical building of the automobile dealership and wherein the one or more of the digital versions of the automobiles is in a virtual location of the digital showroom that corresponds to a physical location of the real-life showroom.

4. The computer program product of claim 1, wherein the program instructions further comprise generating a digital lot outside of the digital replica of the automobile dealership replicating a real-life lot outside of the physical building of the automobile dealership and wherein the one or more of the digital versions of the automobiles is in a virtual location of the digital lot that corresponds to a physical location of the real-life lot.

5. The computer program product of claim 1, wherein the program instructions further comprise generating a virtual test drive by the end user of a selected one of the one or more of the digital versions of the automobiles.

6. The computer program product of claim 1, wherein the digital sales interface includes a network connection to a third-party financial institute, wherein the digital sales interface is configured to provide an approval of financing from the third-party financial institute to the end user for purchase of the one or more of the digital versions of the automobiles.

7. The computer program product of claim 1, wherein the program instructions further comprise generating, by the processor, a smart contract associated with the sale of the one or more of the digital versions of the automobiles.

8. The computer program product of claim 7, wherein the program instructions further comprise determining, by the processor, the smart contract has been fulfilled after a verification of the smart contract through a blockchain network.

9. The computer program product of claim 8, wherein the program instructions further comprise generating a digital token usable in the virtual automobile dealership platform, wherein the sale of the one or more of the digital versions of the automobiles is transacted using the digital token.

10. The computer program product of claim 9, wherein the digital token is a non-fungible token.

11. A computer implemented method of generating a virtual automobile dealership platform, comprising:
receiving, by a processor in a host computer server, a plurality of files associated with a physical automobile dealership, wherein the files include:
images of automobiles currently in stock,
specifications associated with each automobile,
images of a physical building of the automobile dealership, and
digital avatars of personnel in the automobile dealership;
generating a digital replica of the automobile dealership, wherein the digital replica includes a digital version of the automobiles currently in stock and a digital version of the physical building of the automobile dealership;
generating, by the processor, a virtual or augmented reality environment in a user interface that includes the digital replica of the automobile dealership;
providing digital access to an end user of the generated virtual or augmented reality environment that includes the digital replica of the automobile dealership through the user interface;
generating a real-time interaction between the end user and one or more of the digital versions of the automobiles currently in stock through the user interface, wherein the end user is able to walk around and sit in the one or more of the digital versions of the automobiles currently in stock;
generating a digital sales interface in the virtual or augmented reality environment for transacting a sale of the one or more of the digital versions of the automobiles currently in stock;
updating an inventory to remove the one or more of the digital versions of the automobiles currently in stock in response to a sale of the one or more of the digital versions of the automobiles currently in stock; and
upon determining, by the processor, that the one or more of the digital versions of the automobiles has been sold, electronically and automatically updating the virtual or augmented reality environment, removing the one or more of the digital versions of the automobiles from the digital replica of the automobile dealership and from view in the user interface.

12. The method of claim 11, further comprising generating a real-time interaction between the end user and one or more of the digital avatars of personnel in the automobile dealership, wherein the real-time interaction includes one of the digital avatars asking the end user questions, answering questions from the end user, and pointing out features of the one or more of the digital versions of the automobiles.

13. The method of claim 11, further comprising generating a digital showroom replicating a real-life showroom in the physical building of the automobile dealership and wherein the one or more of the digital versions of the automobiles is in a virtual location of the digital showroom that corresponds to a physical location of the real-life showroom.

14. The method of claim 11, further comprising generating a digital lot outside of the digital replica of the automobile dealership replicating a real-life lot outside of the physical building of the automobile dealership and wherein the one or more of the digital versions of the automobiles is in a virtual location of the digital lot that corresponds to a physical location of the real-life lot.

15. The method of claim 11, further comprising generating a virtual test drive by the end user of a selected one of the one or more of the digital versions of the automobiles.

16. The method of claim 11, wherein the digital sales interface includes a network connection to a third-party financial institute, wherein the digital sales interface is configured to provide an approval of financing from the third-party financial institute to the end user for purchase of the one or more of the digital versions of the automobiles.

17. The method of claim 11, further comprising generating, by the processor, a smart contract associated with the sale of the one or more of the digital versions of the automobiles.

18. The method of claim 17, further comprising determining, by the processor, the smart contract has been fulfilled after a verification of the smart contract through a blockchain network.

19. The method of claim 18, further comprising generating a digital token usable in the virtual automobile dealership platform, wherein the sale of the one or more of the digital versions of the automobiles is transacted using the digital token.

20. The method of claim 19, wherein the digital token is a non-fungible token.
